(19) United States
(12) Patent Application Publication
(10) Pub. No.: US 2025/0198236 A1
(43) Pub. Date: Jun. 19, 2025

(54) LADDER WITH CANTILEVERED STEP

(71) Applicant: Werner Co., Greenville, PA (US)

(72) Inventors: David Pozgay, Wilmette, IL (US); Lucindo Sofronio Valenciano, Makati City (PH); Oladapo Kolawole, Frankfort, IL (US); Jeffree Pons, Biñan Laguna (PH)

(21) Appl. No.: 18/542,243

(22) Filed: Dec. 15, 2023

(51) Int. Cl. E06C 7/08; E06C 1/18

(52) U.S. Cl. CPC E06C 7/084; E06C 1/18; E06C 7/081

(57) ABSTRACT

Provided herein is a ladder that includes a cantilevered step. The ladder, for example, may be a stepladder ladder having a cantilevered step disposed at one or more positions on a rail assembly, for example on the front rail assembly. In one illustrative configuration, the cantilevered step may include a first or secured portion that is disposed between a first rail and a second rail of the rail assembly. The cantilevered step may also include a second or extended portion that is cantilevered from the first portion and extends beyond the first rail and the second rail. The second or extended portion of the cantilevered step may be coupled to the first or secured portion along at least two discrete attachment surfaces.

### TECHNICAL FIELD

This disclosure relates generally to ladders and, more specifically, to steps for ladders.

### BACKGROUND

Ladders typically provide access to elevated locations and/or items and may be used in a variety of locations. Depending on the location and/or typical operating conditions in those locations, one or more features or accessories may be utilized with the ladder or built into the ladder to improve stability and/or usability. It may be useful for example, to provide features or accessories, for example, to enhance the comfort and/or stability of users who may be working on a ladder for extended periods of time.

### BRIEF DESCRIPTION OF DRAWINGS

Various needs are at least partially met through the provision of the ladder having a cantilever step described in the following detailed description, particularly when studied in conjunction with the drawings.

FIG. 1 comprises a front top perspective view of a ladder having a cantilevered step, according to a first embodiment;

FIG. 2 comprises a right side view of the ladder of FIG. 1;

FIG. 3A comprises front top perspective view of the ladder of FIG. 1 in a closed position;

FIG. 3B comprises a rear top perspective view of the ladder of FIG. 1 in a closed position;

FIG. 4 comprises a right side view of the ladder of FIG. 1 in a closed position;

FIG. 5 comprises a perspective view of a portion of FIG. 1;

FIG. 6 comprises a top plan view of a portion of FIG. 1 including a cantilevered step;

FIG. 7 comprises a right end view of a portion of FIG. 1 including a cantilevered step and an end cap;

FIG. 8 comprises a right end view of a portion of FIG. 1 including a cantilevered step without an end cap;

FIG. 9 comprises a right end view of a cantilevered step for a ladder, according to a second embodiment;

FIG. 10 comprises a right end view of a cantilevered step for a ladder, according to a third embodiment;

FIG. 11 comprises a right end view of a cantilevered step for a ladder, according to a fourth embodiment;

FIG. 12 comprises a right end view of a cantilevered step for a ladder, according to a fifth embodiment;

FIG. 13 comprises a right end view of a cantilevered step for a ladder, according to a sixth embodiment;

FIG. 14 comprises a right end view of a cantilevered step for a ladder, according to a seventh embodiment; and

FIG. 15 comprises a right end view of a cantilevered step for a ladder, according to a eighth embodiment.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

Provided herein is a ladder or other similar structure that includes one or more cantilevered steps. The ladder, for example, may be a stepladder ladder having a cantilevered step disposed at one or more positions on a rail assembly, for example on a front rail assembly. In one illustrative approach, the cantilevered step includes a first or secured portion that is disposed between a first rail and a second rail of the rail assembly and a second or extended portion that is cantilevered from the first portion and extends beyond the first rail and the second rail and toward a rear rail assembly. The second or extended portion of the cantilevered step may be coupled to the first or secured portion along at least two discrete attachment surfaces. In this manner, the cantilevered portion is supported by the secured portion and is not in direct contact with the rail assembly in one illustrative embodiment. The second or extended portion of the cantilevered step increases the area of the standing surface and may help to enhance comfort and stability for a user, in particular, when a user is on the ladder for extended periods of time.

The first or secured portion of the cantilevered step may include a bottom wall that is opposite a standing surface of the first or secured portion. Further, the second portion (or portions thereof) may have a wall thickness greater than the wall thickness of the first portion (or portions thereof). These features may help to limit the vertical displacement of the second or extended portion of the cantilevered step when the cantilevered step is subjected to a load, thereby strengthening the interface. In addition, limiting the vertical displacement may enhance the perception of stability for a user.

The second or extended portion of the cantilevered step may also include an angled skirt disposed at a distal end of the cantilevered step. The angled skirt may be disposed at an acute angle relative to the standing surface of the cantilevered step. In this manner, the angled skirt may prevent the cantilevered step from with interfering with steps or horizontal bars or other features disposed on the rear rail assembly of the ladder.

The second or extended portion of the cantilevered step may also be shorter than the first or secured portion. In some configurations, the ends of the second or extended portion of the cantilevered step may be tapered such that a proximal end of the extended portion is longer than a distal end of the extended portion. In this manner, the cantilevered step may avoid other ladder components or accessories that are coupled to the rails, such as, for example, spreaders. In this manner, the cantilevered or deeper steps described herein may have multiple lengths and in some configurations multiple widths.

The cantilevered step described herein may be integrated into any type of ladder, including step ladders, ceiling ladders, extension ladders, multi-position ladders, etc. The cantilevered step described herein may also be incorporated into other railed structures such as, for example, a rail assembly having two or more vertical components (e.g., rails, tubes, etc.) joined together by at least one horizontal component (e.g., steps, rungs, tubes, etc.). The other railed structures include, but are not limited to, scaffolds, and work platforms.

In some aspects, a ladder comprises a rail assembly including a first rail and a second rail spaced from and opposite the first rail. The ladder further comprises a cantilevered step coupled to the first rail and the second rail. The cantilevered step includes a secured or first portion disposed between the first rail and the second rail. The first portion of the cantilevered step includes a first wall, a second wall, and a third wall. The first wall forms at least a portion of a standing surface. The second wall and the third wall depend from the first wall. The cantilevered step further includes an extended or second portion coupled to the first portion along the third wall at a first attachment surface and a second attachment surface. The second portion is cantilevered from the first portion such that the second portion extends beyond the rail assembly.

In some aspects, a ladder comprises a front rail assembly including a first front rail and a second front rail spaced from and opposite the first front rail. The ladder also comprises a rear rail assembly coupled to the front rail assembly at a hinged portion. The rear rail assembly have a first rear rail and a second rear rail spaced from and opposite the first rear rail. The ladder further includes a cantilevered step coupled to the front rail assembly. The cantilevered step includes a secured or first portion disposed between the first front rail and the second front rail. The first portion includes a first wall, a second wall, and a third wall. The first wall forms at least a portion of a standing surface. The second wall and the third wall depend from the first wall. The cantilevered step also includes an extended or second portion coupled to the first portion at a first attachment surface disposed on the third wall. The second portion is cantilevered from the first attachment surface such that the second portion extends beyond the first front rail and the second front rail.

In some aspects, a step for a ladder comprises a secured or first portion comprising a first wall, a second wall, a third wall, and a fourth wall. The first wall forms a standing surface. The second wall and the third wall depend from the first wall. The fourth wall is opposite the first wall and extends between the second wall and the third wall. The fourth wall includes a channel formed therein. The channel is disposed adjacent to the third wall. The cantilevered step further includes an extended or second portion coupled to the first portion. The second portion includes a cantilevered wall and an angled skirt. The cantilevered wall is cantilevered from a first attachment surface on the third wall. The angled skirt depends from a distal end of the cantilevered wall and extends inward toward the third wall at an acute angle relative to the cantilevered wall. The angled skirt intersects the third wall at a second attachment surface.

The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

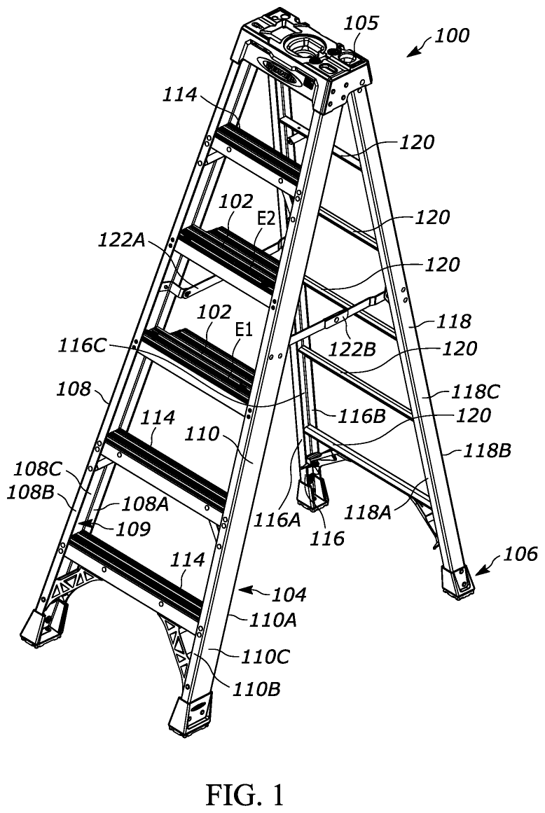

Referring now to the drawings, and in particular to FIGS. 1-8, a ladder 100 including cantilevered steps 102 is shown. The cantilevered steps extend or are cantilevered beyond the rails of the ladder 100. The cantilevered steps 102 may provide an extended standing surface to provide comfort to a user of the ladder 100.

Though the ladder 100 is depicted with two cantilevered steps 102, it is contemplated that one or more and, in some approaches, even all of the steps of the ladder 100 may be cantilevered steps. In some configurations, the ladder 100 includes at least one cantilevered step 102 in a working zone of the ladder 100 where a user is likely to stand for extended periods of time. For example, at least one cantilevered step 102 may be disposed at a height of between about 1 foot and about 6 feet or between about 1 foot and about 5 feet, as measured from the ground to the top of the cantilevered step when the ladder 100 is in the open position.

As shown, the ladder 100 is a step ladder having a front rail assembly 104 and a rear rail assembly 106. The front rail assembly 104 is coupled to the rear rail assembly 106 at a hinged portion 105. The front rail assembly 104 includes a first front rail 108 spaced from and opposite a second front rail 110. The first front rail 108 is parallel to the second front rail 110. The front rail assembly 104 further includes a plurality of rungs or steps 114 disposed between the first front rail 108 and the second front rail 110. The steps 114 may be standard steps, that is, steps with a consistent length and width confined within the footprint of the first front rail 108 and the second front rail 110 and with no portion cantilevered beyond the first front rail 108 and the second front rail 110. The rear rail assembly 106 includes a first rear rail 116 spaced from and opposite a second rear rail 118. The first rear rail 116 is parallel to the second rear rail 118. The rear rail assembly 106 includes a plurality of horizontal bars 120 disposed between the first rear rail 116 and the second rear rail 118. The cantilevered step 102 is disposed in the front rail assembly 104.

In one illustrative configuration, the first front rail 108, the second front rail 110, the first rear rail 116, and the second rear rail 118 are C-shaped. In some configurations, the first front rail 108 includes a first front inner flange 108A spaced from a first front outer flange 108B by a first front web 108C. The first front inner flange 108A, the first front outer flange 108B, and the first front web 108C form a first front channel 109 that extends along the first front rail 108. The second front rail 110 includes a second front inner flange 110A spaced from a second front outer flange 110B by a second front web 110C. The second front inner flange 110A, the second front outer flange 110B, and the second front web 110C form a second front channel 111 (not shown) that extends along the second front rail 110. Similarly, the first rear rail 116 may include a first rear inner flange 116A spaced from a first front outer flange 116B by a first rear web 116C. The second rear rail 118 also typically includes a second rear inner flange 118A spaced from a second rear outer flange 118B by a first rear web 118C.

The rails of the ladder 100, however, may be any suitable shape. For example, in some configurations, the rails of the ladder 100 may be round having a generally circular cross-section, D-shaped having a flat side that rests against the ladder steps or rungs and a curved side, square or rectangular shaped, I-beam shaped having a cross-sectional shape generally resembling the letter “I”, or box-sections having a square or rectangular cross-sectional shape with a hollow interior.

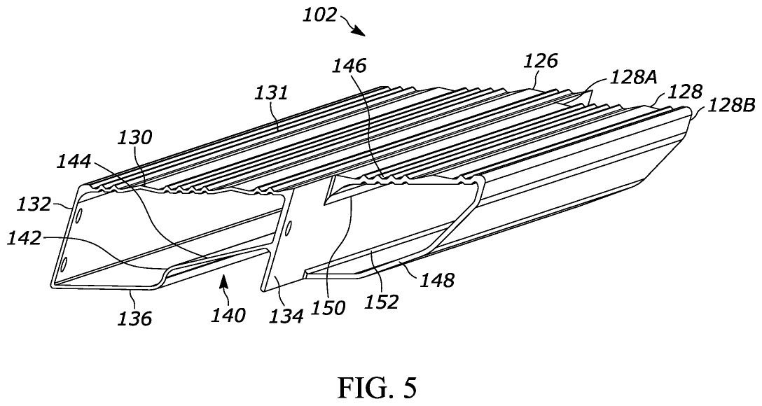

Turning now to FIGS. 5-8, the cantilevered step 102 of the ladder 100 is shown in detail. The cantilevered step 102 includes a first portion 126 and a second portion 128.

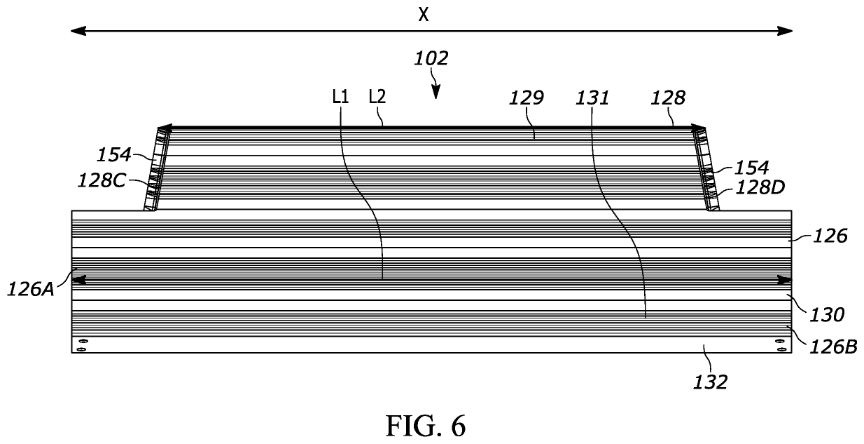

The first portion 126 of the cantilevered step 102 is disposed between the first front rail 108 and the second front rail 110. The first portion 126 has a length L1 (see FIG. 6). Once installed, the length L1 may be the distance between the first front web 108C of the first front rail 108 and the second front web 110C of the second front rail 110. The first portion 126 has a first end portion 126A and a second end portion 126B disposed opposite the first end portion 126A. The first end portion 126A that is received or nested within the first front channel 109 of the first front rail 108. The second end portion is received by or nested within the second front channel 111 of the second front rail 110.

The first portion 126 includes a first surface, segment, or wall 130, a second surface, segment, or wall 132, a third surface, segment, or wall 134, and a fourth surface, segment, or wall 136. The first wall 130 may form at least a portion of a standing surface of the cantilevered step 102. The second wall 132 and the third wall 134 depend from the first wall 130, and accordingly may be sidewalls of the first portion 126. The fourth wall 136 is disposed opposite and spaced from the first wall 130 and extends between the second wall 132 and the third wall 134. The fourth wall 136 may be a bottom wall of the first portion 126.

The first wall 130 may include a tread to enhance grip or provide slip resistance. In some approaches, first wall 130 or the entire standing surface of the cantilevered step 102 may have the same tread pattern as the steps 114. In some examples, the first wall 130 includes a plurality of pips 131. As used herein a “pip” refers to a protrusion or ridge that extends laterally across at least a portion of step (e.g., along the length L1 or L2 or in the extrusion direction of the step). In some approaches, the pips 131 may be disposed in pip groupings of between about 2 pips to about 10 pips, about 2 pips to about 8 pips, or about 2 pips to about 4 pips. In other configurations, other configurations of protrusions or ridges may be employed, such as, for example, discrete circular bulges, cross hatching and/or any other pattern of interest.

The second wall 132 may be coupled to the first front rail 108 and to the second front rail 110. For example, the second wall 132 may be attached to the first front rail 108 and the second front rail 110 via any suitable attachment mechanism such as via fasteners (e.g., rivets), welding, swaging, or bonding. In some examples, the second wall 132 may include one or more openings that receive fasteners to attach the cantilevered step 102 to the first front inner flange 108A of the first front rail 108 and to the second front inner flange 110A of the second front rail 110.

The third wall 134 may be coupled to the first front rail 108 and to the second front rail 110. The third wall 134 may be attached to the first front rail 108 and the second front rail 110 via any suitable attachment mechanism such as via fasteners (e.g., rivets), welding, or bonding. In some examples, the third wall 134 may include one or more openings that receive fasteners to attach the cantilevered step 102 to the first front inner flange 108A of the first front rail 108 and to the second front inner flange 110A of the second front rail 110.

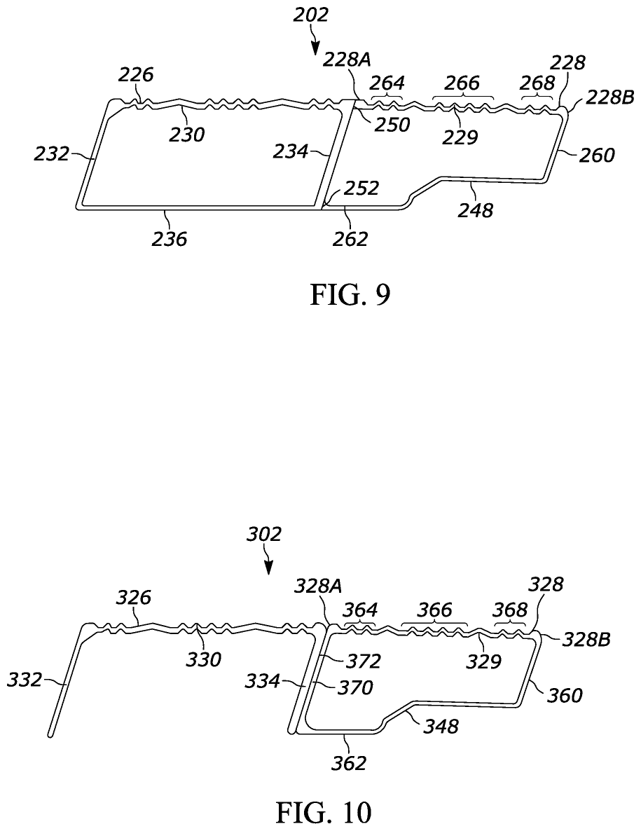

The fourth wall 136 may include an indentation or a channel 140 formed therein. By one approach, the channel 140 is positioned adjacent to third wall 134. The channel 140 may be defined by a first channel wall 142, a second channel wall 144, and at least a portion of the third wall 134. The first channel wall 142 is disposed opposite the third wall 134 of the first portion 126. In one illustrative approach, the second channel wall 144 extends between the first channel wall 142 and the third wall 134 of the first portion. The second channel wall 144 is typically sloped or disposed at an angle relative to the first wall 130 of the first portion 136. In some configurations, the second channel wall 144 is disposed at an angle of between about 90 degrees and about 150 degrees, about 100 degrees and about 140 degrees, or about 110 degrees and about 130 degrees relative to the third wall 134. In some embodiments, the fourth wall 136 may not include the channel 140 (see e.g., FIG. 9).

In some examples, the first portion 126 of the cantilevered step 102 may have a width W1-A that is between about 2 inches and about 6 inches, between about 2 inches and about 5 inches, between about 2.5 inches and about 4.5 inches, or between about 3 inches and about 4 inches. In some examples, the one or more walls of the first portion 126 may have a wall thickness of between about 0.02 inch and about 0.10 inches, between about 0.03 inch and about 0.08 inch, between about 0.03 inch and about 0.07 inch, or between about 0.035 inches and about 0.055 inch. In yet other examples, the third wall 134 (e.g., the wall shared between the first portion 126 and the second portion 128) may be thicker than one or more the first wall 130, the second wall 132, and the fourth wall 136 of the first portion 126. It is contemplated that increasing the wall thickness of the third wall 134 may help to reduce the maximum deflection of the cantilevered step 102. For example, the third wall 134 may have a wall thickness of between about 0.03 inch and about 0.14 inch, between about 0.04 inch and about 0.12 inch, about 0.05 inch and about 0.10 inch, or between about 0.06 inch and about 0.09 inch.

The first portion 126 may have a cross-sectional profile that is generally C-shaped, D-shaped, and/or box shaped, among others. For example, when the cross-sectional profile of the first portion 126 is generally C-shaped, the first portion 126 may lack the fourth wall 136. In some examples, the first portion 126 may have the same cross-section profile as the steps 114. In other examples, the first portion 126 may have a different cross-sectional profile than the steps 114.

In some embodiments, the ladder 100 may include a ladder top that is or includes one or more rubber bumpers coupled thereto so that the ladder 100 may securely lean against another structure such as a wall, pole, corner, wall stud, etc. The cantilevered step 102 may also include a locking mechanism on the horizontal bars 120 that is received by the channel 140. In operation the locking mechanism may slide down the slide down the second portion 128 and then rest in the 140 to secure the front rail assembly 104 to the rear rail assembly 106, for example, so that the ladder may securely lean against another structure.

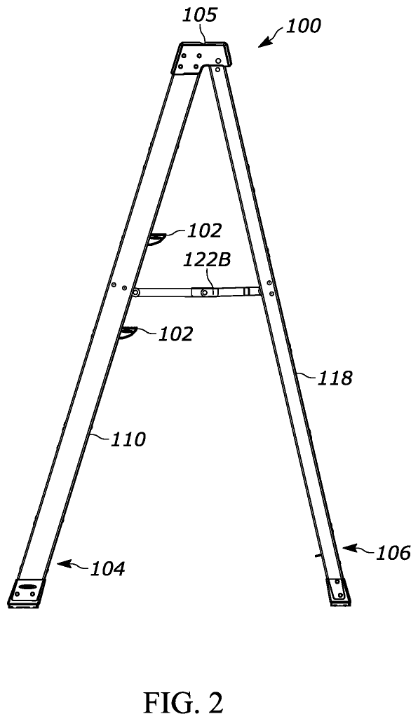

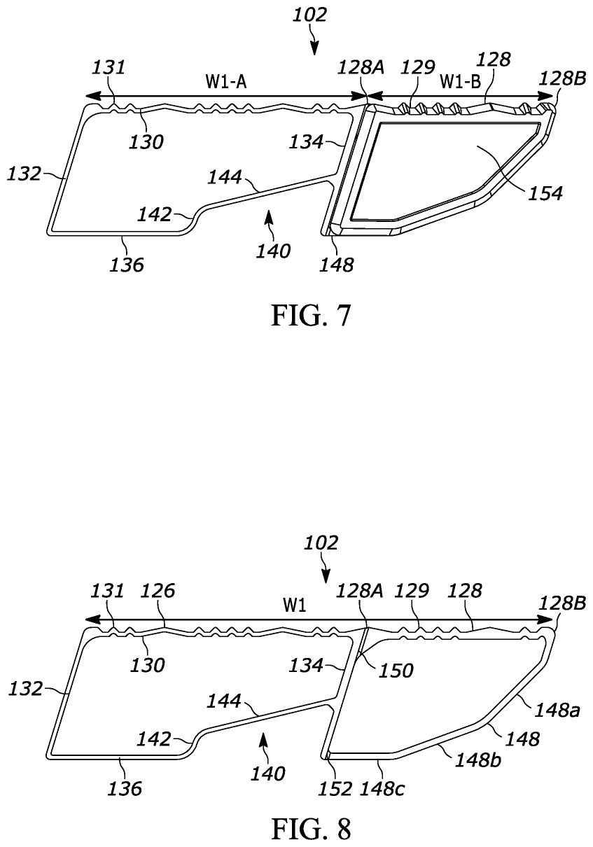

The second portion 128 of the cantilevered step 102 is cantilevered from the first portion 126. In this manner, the second portion 128 extends beyond the first front rail 108 and the second front rail 110 toward the rear rail assembly 106 (see, e.g., FIG. 2). The second portion 128 of the cantilevered step 102 has a length L2 (see FIGS. 6-7). In some approaches, the length L2 of the second portion 128 of the cantilevered step 102 is shorter than the length L1 first portion 126 of the cantilevered step 102. Thus, the cantilevered step 102 may have at least two different lengths along different portions of its width W.

The second portion 128 includes a cantilevered wall 129 and an extension or angled skirt 148 that depends from the cantilevered wall 129. As discussed below, the extension or angled skirt may include a number of angles, segments, surfaces, or portions thereof. Further, the cantilevered wall 129 typically extends from the first portion 126 along a first attachment point, line, or surface 150. The cantilevered wall 129 may form at least a portion of the standing surface on the cantilevered step 102. Like the second wall 132, the cantilevered wall 129 may also include a tread and one or more pips to enhance grip.

By one approach, the angled skirt 148 extends toward the third wall 134 and joins the third wall at a second point, line, or attachment surface 152. The angled skirt 148 creates an opening in the second portion 128 that may help the cantilevered step 102 avoid the horizontal bars 120 that are disposed in the rear rail assembly 106. In some examples, the angled skirt 148 or portion or segments thereof may be disposed at an angle of between about 10 degrees and about 60 degrees, between about 10 degrees and about 50 degrees, between about 10 degrees and about 30 degrees, between about 15 degrees and about 25 degrees, between about 35 degrees and about 55 degrees, between about 40 degrees and about 50 degrees relative to the cantilevered wall 129. In some examples, at least one portion or segment of the angled skirt 148 may be disposed approximately parallel to or at an angle of less than 10 degrees relative to the cantilevered wall 129.

In some examples, the angled skirt 148 may comprise at least two discrete segments. In the first embodiment, the angled skirt 148 includes a first segment 148a, a second segment 148b, and a third segment 148c. In one example, the first skirt 148a may be disposed at an angle of between about 10 degrees and about 40 degrees, between about 10 degrees and about 30 degrees, or between about 15 degrees and about 25 degrees relative to the cantilevered wall 129. In one example, the first skirt 148a may be disposed at an angle of between about 20 degrees and about 60 degrees, between about 35 degrees and about 55 degrees, between about 40 degrees and about 50 degrees relative to the cantilevered wall 129. In one example, the first segment 148c may be disposed approximately parallel to or at an angle of less than 10 degrees relative to the cantilevered wall 129.

The second portion 128 is coupled to the first portion 126 at two attachment lines or surfaces 150, 152. The first attachment surface 150 includes the intersection of the cantilevered wall 129 with the third wall 134 of the first portion 126. The second attachment surface 152 includes the intersection of the angled skirt 148 with the third wall 134 of the first portion 126. In some configurations, the first portion 126 does not contact the first front rail 108 or the second front rail 110 when the cantilevered step 102 is installed in the ladder 100. As such, the second portion 128 may only be supported by the first portion 126 and the interface of the first portion 126 with the first front rail 108 and the second front rail 110.

The second portion 128 has a proximal end portion 128A and a distal end portion 128B. The proximal end portion 128A is adjacent to the first portion 126 of the cantilevered step 102. The distal end portion 128B of the proximal end portion 128A is opposite the proximal end portion 128A. In some configurations, the length L2 of the second portion 128 may decrease in a direction extending from the proximal end portion 128A to the distal end portion 128B.

The second portion 128 has a first end portion 128C and a second end portion 128D. In some configurations, first end portion 128C and the second end portion 128D are tapered or angled relative to a lateral direction X of the cantilevered step 102 (see FIG. 6). The decreasing length L2 of the second portion 128 results in the taper of the first end portion 128C and the second end portion 128D. In some examples, the first end portion 128C and the second end portion 128D may be disposed at an angle between about 1 degree and about 30 degrees, between about 5 degrees and about 20 degrees, or between about 5 degrees and about 15 degrees relative to the lateral direction X of the cantilevered step 102. Angling the second portion 128 in this manner may help the cantilevered step 102 to clear the spreaders 122A, 122B when the ladder is moved between an open position and a closed position.

In some examples, the second portion 128 may have a width W1-B (see, e.g., FIG. 7) that is between about between about 1 inch and about 6 inches, between about 1 inch and about 5 inches, between about 1 inch and about 4 inches, between about 1 inch and about 3 inches, or, in some aspects, may be about 2 inches.

In some configurations, the second portion 128 or portions thereof may have a wall thickness that is greater than a wall thickness of the first portion 126. For example, one or more of the cantilevered wall 129 and the angled skirt 148 of the second portion 128 may have a wall thickness that is greater than a wall thickness of one or more of the first wall 130, the second wall 132, or the fourth wall 136 of the first portion 126. Further, in some configurations, a wall thickness of the third wall 134 may be greater than the wall thickness of the cantilevered wall 129 and the angled skirt 148. In some examples, the one or more walls of the second portion 128 (e.g., the cantilevered wall 129 or the angled skirt 148) may have a wall thickness of between about 0.04 inch and about 0.10 inch, between about 0.05 inch and about 0.09 inch, between about 0.05 inch and about 0.09 inch, or between about 0.06 inch and about 0.08 inch.

In some examples, the cantilevered step 102 may have a maximum deflection of between about 0.01 inches and about 0.20 inches, between about 0.03 inches and about 0.18 inches, between about 0.05 inches and about 0.15 inches, or between about 0.08 inches and about 0.12 inches. A maximum deflection within the aforementioned ranges may provide the perception of stability to a user of the ladder 100. As used herein, maximum deflection may refer to the vertical displacement of the second portion 128 of the cantilevered step 102 when a load is applied to the cantilevered step 102. The load used to determine the maximum deflection is twice the duty rating of the ladder with a 10% safety factor. In one non-limiting example, if the duty rating of the ladder is 300 pounds, the load used to determine the maximum deflection will be 660 pounds.

In some configurations, the cantilevered step 102 may include end caps 154. By one approach, the end caps 154 are inserted into the first end portion 128C and the second portion 128 of the second portion 128. In some examples, the end caps 154 may be attached to the first end portion 128C and the second end portion 128D via one or more fasteners, such as rivets. In other examples, the end caps 154 may be held in place via a friction fit connection. It is contemplated that any suitable attachment mechanism may be used to secure the end caps 154 to the second portion 128 of the cantilevered step 102.

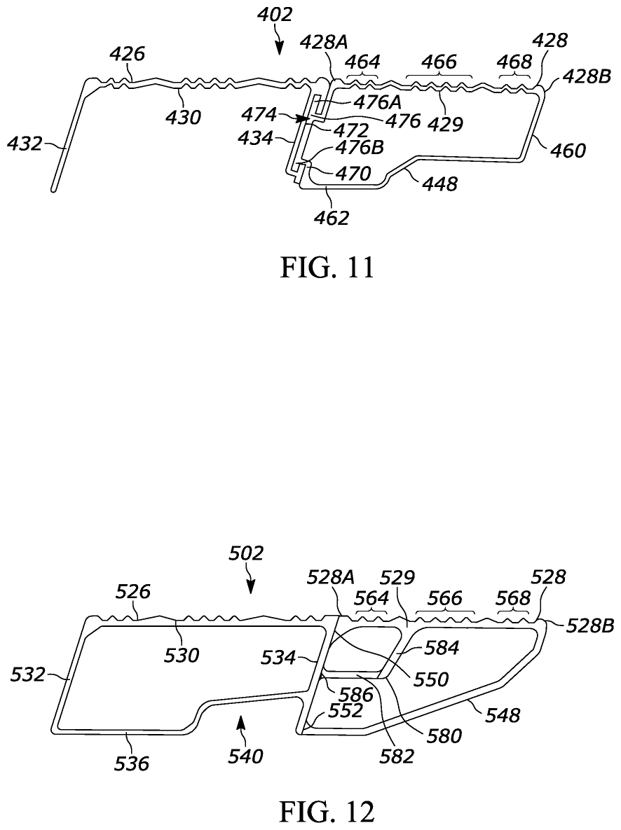

In some approaches, the cantilevered step 102 may be formed as a one-piece extrusion such that the first portion 126 and the second portion 128 are formed as a single piece having a fixed cross-sectional profile along its length. In other approaches, the first portion 126 and second portion 128 may be formed as two separate pieces that are coupled together, for example, via a friction fit connection, fasteners, bonding, or otherwise. In such an approach, the first portion 126 may be a one-piece extrusion and the second portion 128 may be a separate one-piece extrusion. Examples of two-piece cantilevered steps are depicted in FIGS. 10 and 11.

Returning now to FIGS. 1-4, the ladder 100 includes two cantilevered steps 102. The lower cantilevered step may be shorter than the upper cantilevered step. For example, the length (e.g., L1) of the lower step may be greater than the length (e.g., L1) of the upper step. In some examples, the length (e.g., L1) of the lower cantilevered step may be between about 13 inches to about 21 inches or about 15 inches to about 19 inches. In some examples, the length (e.g., L1) of the upper cantilevered step may be between about 10 inches to about 20 inches or about 13 to about 17 inches. As shown in FIG. 1, the lower cantilevered step may have an exposed length E1 of between about 12 inches and about 20 inches, between about 12 inches and about 18 inches, between about 14 inches and about 18 inches, or between about 16.5 inches and about 17.5 inches. The upper cantilevered step may have an exposed length E2 of between about 9 inches and about 19, between about 11 inches and about 17 inches, between about 12 inches and about 16 inches, or between about 13 inches and about 15 inches.

The ladder 100 further includes spreaders 122A, 122B coupled to the front rail assembly 104 and the rear rail assembly 106. The first spreader 122A is coupled to the first front rail 108 and the first rear rail 116 and may include one or more hinge or pivot points that allow the first spreader 122A to fold and unfold. The second spreader 122B is coupled to the second front rail 110 and the second rear rail 118 and may include one or more hinge or pivot points that allow the second spreader 122B to fold and unfold. The spreaders 122 may fold or unfold, for example, when a force is applied to the front rail assembly 104 and/or to the rear rail assembly 106 to spread or collapse the ladder 100.

The ladder 100 may be foldable such that the front rail assembly 104 and rear rail assembly 106 may be spread or collapsed via the hinged portion 105, for example, for storage or transport. As such, the ladder 100 may assume a first, open position in which the front rail assembly 104 is spaced from or spread apart from the rear rail assembly 106. The ladder 100 may also assume a second, closed position in which the front rail assembly 104 is adjacent to or collapsed against the rear rail assembly 106.

In the open position, the spreaders 122A, 122B of the ladder 100 unfold and secure the front rail assembly 104 relative to the rear rail assembly 106. FIGS. 1-2 show the ladder in the open position.

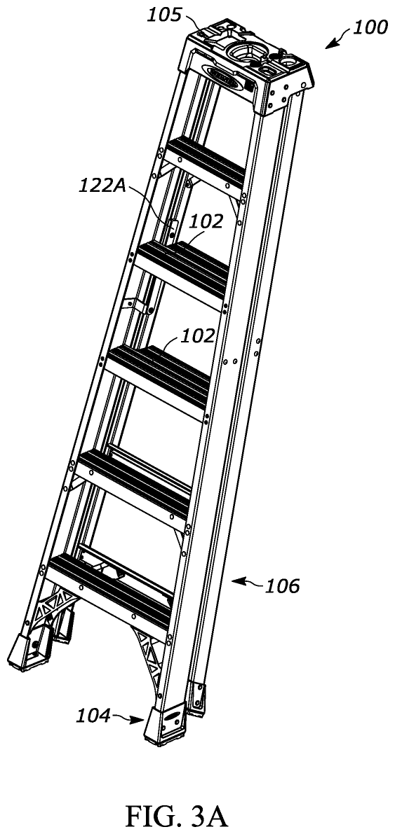

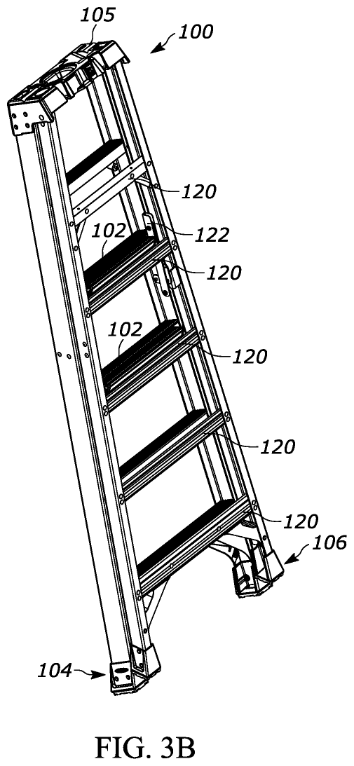

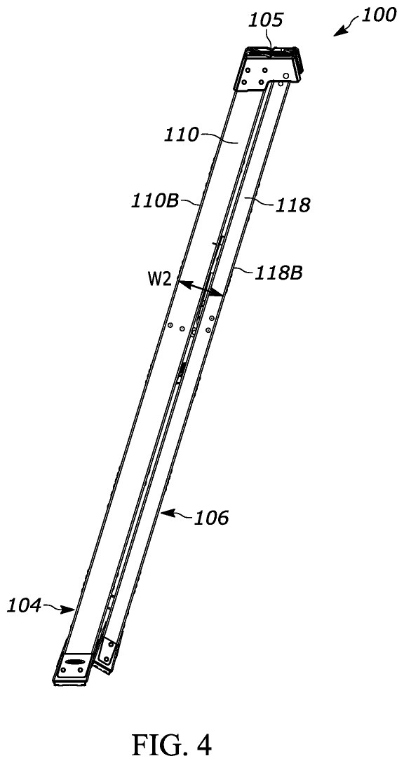

In the closed position, the spreaders 122A, 122B fold and allow the front rail assembly 104 to collapse against or move toward to the rear rail assembly 106. FIGS. 3-4 show the ladder 100 in the closed position. When the ladder is in the closed position, the cantilevered step 102 nests between the first spreader 122A and the second spreader 122B. In some configurations, the cantilevered step 102 has a has a total step width W1 (see FIG. 8). The total step width W extends between the second wall 132 and the distal end portion 128B of the second portion 128. Further, in the closed position, the ladder 100 has a ladder width W2. The ladder width W2 extends from the front rail assembly 104 to the rear rail assembly 106 and, in particular, from first front outer flange 108B to the second front outer flange 110B. As shown in FIG. 4, the total step width W1 is less than the ladder width W2. Thus, the cantilevered step 102 fits within the profile of the ladder 100 in the closed position.

In some examples, the total step width W may be between about 3 inches and about 12 inches, between about 3 inches and about 10 inches, between about 3 inches and about 8 inches, between about 3 inches and about 7 inches, between about 3.5 inches and about 8.5 inches, between about 4 inches and about 8 inches, between about 4 inches and about 6 inches, or, in some aspects, may be about 5 inches.

FIG. 9 shows a cantilevered step 202 according to a second embodiment. In the second embodiment, the cantilevered step 202 has an angled skirt 148 with an alternative shape. Additionally, the first portion 226 of the cantilevered step 202 lacks an indention or channel (e.g., channel 140) on the bottom wall. Elements in the second embodiment that are similar to those in the first embodiment have been given similar reference numbers in the two-hundred series and only the general differences will be discussed below. For example, the cantilevered step 102 described in the first embodiment is numbered as cantilevered step 202 in the second embodiment.

The first portion 226 of the cantilevered step 202 includes a first wall 230, a second wall 232, a third wall 234, and a fourth wall 236. In the first portion 226 of the cantilevered step 202, the fourth wall 236 does not include a channel formed therein. Rather, the fourth wall 236 is generally straight from the second wall 232 to the third wall 234. In this manner, the first portion 226 has a generally box-shaped cross-sectional profile.

The second portion 228 of the cantilevered step 202 includes a first cantilevered wall 229, a skirt 260, an angled skirt 248, and a second cantilevered wall 262. The cantilevered wall 229 is cantilevered from the third wall 234 at a first attachment surface 250. In some approaches, the cantilevered wall 229 includes a tread that differs from the tread of the cantilevered wall 129 in the first embodiment. For example, the tread on the cantilevered wall 229 includes a first pip grouping 264 including two pips, a second pip grouping 266 including four pips, and a third pip grouping 268 including two pips. The tread pattern on the cantilevered wall 229 is the same as the tread pattern on the first wall 230 of the first portion 226. The skirt 260 depends from the cantilevered wall 229 at the distal end 228B of the second portion 228. The skirt 260 may be generally parallel to the third wall 234 and the second wall 232 of the first portion 226. The angled skirt 248 extends inward from the skirt 260 towards the second cantilevered wall 262. The second cantilevered wall 262 is cantilevered from the third wall 234 at a second attachment surface 252.

In some approaches, the cantilevered step 202 may have a maximum displacement of between about 0.02 inches and about 0.08 inches, between about 0.02 inches and about 0.06 inches, or between about 0.02 inches and about 0.05 inches.

FIG. 10 shows a cantilevered step 302 according to a third embodiment. In the third embodiment, the first portion 326 of the cantilevered step 302 is reduced. By one approach, the first portion 326 lacks a fourth wall (e.g., the fourth wall 236). Additionally, the first portion 326 and the second portion 328 of the cantilevered step 302 are separate pieces that are coupled together, for example, via fasteners. Elements in the third embodiment that are similar to those in the second embodiment have been given similar reference numbers in the three-hundred series and only the general differences will be discussed below. For example, the cantilevered step 202 described in the second embodiment is numbered as cantilevered step 302 in the third embodiment.

The first portion 326 of the cantilevered step 302 includes a first wall 330, a second wall 332, and a third wall 334. The first portion 236 does not include a fourth or bottom wall. As a result, the cross-sectional profile of the first portion 326 is generally C-shaped.

The second portion 328 of the cantilevered step 302 includes a first cantilevered wall 329, a first skirt 360, an angled skirt 348, and a second cantilevered wall 362. The second portion 328 further includes a second skirt 370. The second skirt 370 depends from the first cantilevered wall 329 at a proximal end 328A of the cantilevered step 302. In some configurations, the second skirt 370 may be generally parallel to the first skirt 360. Further, the second cantilevered wall 362 may be generally parallel to the first cantilevered wall 329.

Whereas in the second embodiment the third wall 234 is shared between the first portion 226 and the second portion 228, in the third embodiment the second portion 328 includes the second skirt 370, which is coupled to the third wall 334 via fasteners, such as rivets. It is contemplated that any suitable fastener may be used to couple the second skirt 370 of the second portion 328 to the third wall 334 of the first portion 326.

Further, whereas in the second embodiment the second portion 228 is coupled to or cantilevered from the first portion 226 at two discrete attachment surfaces 250, 252, in the third embodiment the second portion 328 is coupled to the first portion 326 at a larger, single surface, attachment surface 372. As shown in FIG. 10, the interface between the third wall 344 and the second skirt 370 extends from adjacent the top to adjacent the bottom. The attachment surface 372 is a planar face of the second skirt 370 that mates with the third wall 334 of the first portion 326. The attachment surface 372 and the third wall 334 may have corresponding openings (not shown) through which fasteners may be inserted to couple the third wall 334 to the second skirt 370.

In some approaches, the cantilevered step 302 may have a maximum displacement of between about 0.08 inches and about 0.20 inches, between about 0.10 inches and about 0.18 inches, or between about 0.12 inches and about 0.16 inches.

FIG. 11 shows a cantilevered step 402 according to a fourth embodiment. In the fourth embodiment, the cantilevered step 402 includes a first portion 426 that lacks a bottom or fourth wall. Further, in the cantilevered step 402 the first portion 426 is coupled to the second portion 428 via a slot and corresponding projection. Elements in the fourth embodiment that are similar to those in the third embodiment have been given similar reference numbers in the four-hundred series and only the general differences will be discussed below. For example, the cantilevered step 302 described in the third embodiment is numbered as cantilevered step 402 in the fourth embodiment.

The first portion 426 of the cantilevered step 402 includes a first wall 430, a second wall 432, and a third wall 434. The first portion 436 does not include a fourth or bottom wall. As a result, the cross-sectional profile of the first portion 426 is generally C-shaped. The third wall 434 includes a slot or groove 474 formed therein. In one example, the slot 474 may be generally T-shaped slot (e.g., having a t-shaped cross-sectional profile). Though the slot 474 may be formed in any suitable geometry for mating with a portion of the second portion 428.

The second portion 428 of the cantilevered step 402 includes a first cantilevered wall 429, a first skirt 460, an angled skirt 448, and a second cantilevered wall 462. The second portion 428 further includes a second skirt 470. The second skirt 470 depends from the first cantilevered wall 429 at a proximal end 428A of the cantilevered step 402. In some configurations, the second skirt 470 may be generally parallel to the first skirt 460. The second skirt 470 includes a projection 476. The projection 476 may have a geometry corresponding with the geometry of the slot 474 on the third wall 434. In one example, the projection 476 may be T-shaped, having a first arm 476A and a second arm 476B. The projection 476 engages the slot 474 along the attachment surface 472.

Whereas in the third embodiment the third wall 334 of the first portion 326 is coupled to the second skirt 370 of the second portion 428 via fasteners, in the fourth embodiment, the third wall 434 includes the slot 474 and the second skirt 470 includes the projection 476 which is received by the slot 474 to couple the first portion 426 to the second portion 428.

In some approaches, the cantilevered step 402 may have a maximum displacement of between about 0.02 inches and about 0.14 inches, between about 0.04 inches and about 0.14 inches, or between about 0.06 inches and about 0.12 inches.

FIG. 12 shows a cantilevered step 502 according to a fifth embodiment. In the fifth embodiment, the second portion 528 of the cantilevered step 502 includes a cross-brace 580 with is disposed in the hollow interior of the second portion 528. Elements in the fifth embodiment that are similar to those in the first embodiment have been given similar reference numbers in the five-hundred series and only the general differences will be discussed below. For example, the cantilevered step 102 described in the first embodiment is numbered as cantilevered step 502 in the fifth embodiment.

The first portion 526 of the cantilevered step 502 includes a first wall 530, a second wall 532, a third wall 534, and a fourth wall 536. In the first portion 526 of the cantilevered step 502, the fourth wall 536 includes a channel 540 formed therein.

The second portion 528 of the cantilevered step 502 includes a cantilevered wall 529 and an angled skirt 548. The cantilevered wall 529 is cantilevered from the third wall 534 at a first attachment surface 550. The cantilevered wall 529 includes a tread that differs from the tread of the cantilevered wall 129 in the first embodiment. For example, the tread on the cantilevered wall 529 includes a first pip grouping 564 including two pips, a second pip grouping 566 including four pips, and a third pip grouping 568 including two pips. The tread pattern on the cantilevered wall 529 may be the same as the tread pattern on the first wall 530 of the first portion 526. The angled skirt 548 extends toward the third wall 534 and joins the third wall at a second attachment surface 552.

The second portion 528 further includes a buttress or cross-brace 580. The cross-brace 580 is formed from a third cantilevered wall 582 and a rib 584. The third cantilevered wall 582 is cantilevered from the third wall 534 at a third attachment surface 586. In some configurations, the third cantilevered wall 582 may extend generally parallel to the cantilevered wall 529. The rib 584 depends from the cantilevered wall 529. The rib 584 is disposed between the proximal end 528A and the distal end 528B of the second portion 528. In some configurations, the rib 584 is disposed between the first pip grouping 564 and the second pip grouping 566 on the cantilevered wall 529.

The cross-brace 580 may help to secure an end cap to the second portion 528 of the cantilevered step 502. For example, the cross-brace may couple to a corresponding geometry on an end cap to provide a friction-fit connection between the end cap and the cantilevered step 502. The cross-brace 580 may also reinforce the second portion 528 to resist deflection.

In some approaches, the cantilevered step 502 may have a maximum displacement of between about 0.01 inches and about 0.12 inches, between about 0.02 inches and about 0.1 inches, or between about 0.03 inches and about 0.07 inches.

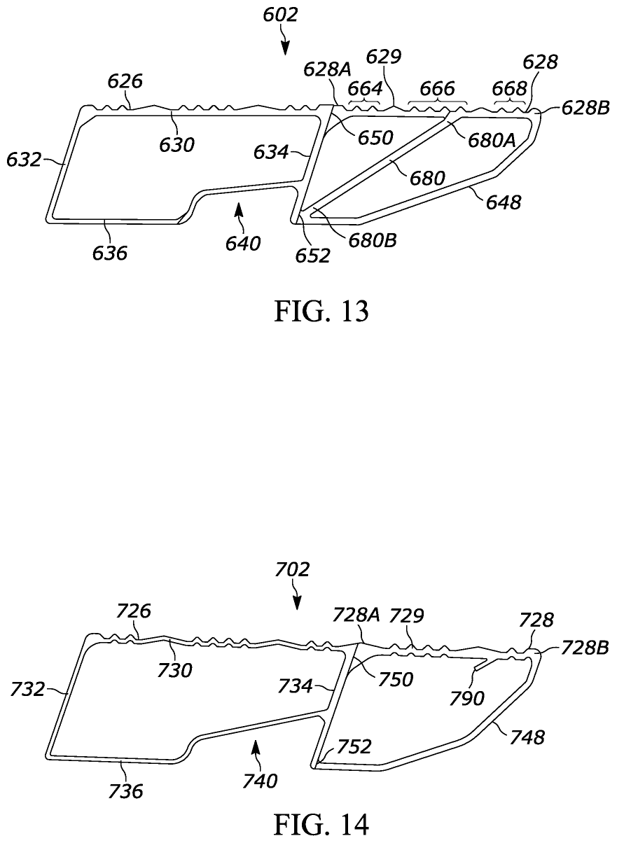

FIG. 13 shows a cantilevered step 602 according to a sixth embodiment. In the sixth embodiment, the second portion 628 of the cantilevered step 602 includes a buttress or cross-brace. Elements in the sixth embodiment that are similar to those in the fifth embodiment have been given similar reference numbers in the six-hundred series and only the general differences will be discussed below. For example, the cantilevered step 052 described in the fifth embodiment is numbered as cantilevered step 602 in the sixth embodiment.

Similar to the sixth embodiment, the second portion 528 of the cantilevered step 502 includes the cross-brace 680. However, whereas the cross-brace 580 in the fifth embodiment includes two discrete segments (e.g., the third cantilevered wall 582 and the rib 584), the cross-brace 680 in the second embodiment is a single discrete segment. Further, the cross-brace 680 intersects the third wall 634 at the second attachment surface 652. Accordingly, the second portion 628 is only coupled to the first portion 626 at two attachment surfaces (e.g., the first attachment surface 550 and the second attachment surface 552).

The first portion 626 of the cantilevered step 602 includes a first wall 630, a second wall 632, a third wall 634, and a fourth wall 636. In the first portion 626 of the cantilevered step 602, the fourth wall 636 includes a channel 640 formed therein.

The second portion 628 of the cantilevered step 602 includes a cantilevered wall 629 and an angled skirt 648. The cantilevered wall 629 is cantilevered from the third wall 634 at a first attachment surface 650. The angled skirt 648 extends inward toward the third wall 634 at an acute angle relative to the cantilevered wall 629 and joins the third wall 634 at a second attachment surface 652.

The second portion 628 further includes the cross-brace 680. The cross-brace 680 depends from the cantilevered wall 629. The cross-brace 680 extends across the hollow opening in the interior of the second portion 628. The cross-brace 680 has a first end 680A that is coupled to the cantilevered wall 629 between the proximal end 628A and the distal end 628B of the second portion 628. In some configurations, the first end 680A of the cross-brace 680 is disposed between the first pip grouping 664 and the third pip grouping 668 and, in some examples, may adjacent to the second pip grouping 666. The cross-brace 680 has a second end 680B that is coupled to or intersects the third wall 634 and the angled skirt 648 at or adjacent to the second attachment surface 652.

In some approaches, the cantilevered step 602 may have a maximum displacement of between about 0.01 inches and about 0.12 inches, between about 0.02 inches and about 0.1 inches, or between about 0.03 inches and about 0.07 inches.

FIG. 14 shows a cantilevered step 702 according to a seventh embodiment. In the seventh embodiment, the second portion 728 of the cantilevered step 702 includes a rib 790 that extends into the hollow opening inside the second portion 728. Elements in the seventh embodiment that are similar to those in the first embodiment have been given similar reference numbers in the seven-hundred series and only the general differences will be discussed below. For example, the cantilevered step 102 described in the first embodiment is numbered as cantilevered step 702 in the seventh embodiment.

The first portion 726 of the cantilevered step 702 includes a first wall 730, a second wall 732, a third wall 734, and a fourth wall 736. In the first portion 726 of the cantilevered step 702, the fourth wall 736 includes a channel 740 formed therein.

The second portion 728 of the cantilevered step 702 includes a cantilevered wall 729 and an angled skirt 748. The cantilevered wall 729 is cantilevered from the third wall 734 at a first attachment surface 750. The angled skirt 748 extends inward toward the third wall 734 at an acute angle relative to the cantilevered wall 729 and joins the third wall 734 at a second attachment surface 752.

The second portion 728 further includes the rib 790. The rib 790 depends from the cantilevered wall 729 and is disposed between the proximal end portion 728A and the distal end portion 728B of the second portion 728. The rib 790 partially extends into the hollow opening in the interior of the second portion 728. By one approach, the rib 790 extends inward toward the third wall 734 at an acute angle relative to the cantilevered wall 729, The rib 790 may help to secure an end cap to the second portion 728 of the cantilevered step 702. For example, the rib 790 may couple to a corresponding geometry on an end cap to provide a friction-fit connection between the end cap and the cantilevered step 702. In some examples, the rib 790 may have a length of between about 0.01 inches and about 0.75 inches, between about 0.05 inches and about 0.60 inches, or between about 0.10 inches and about 0.50 inches.

In some approaches, the cantilevered step 702 may have a maximum displacement of between about 0.04 inches and about 0.16 inches, between about 0.06 inches and about 0.14 inches, or between about 0.08 inches and about 0.12 inches.

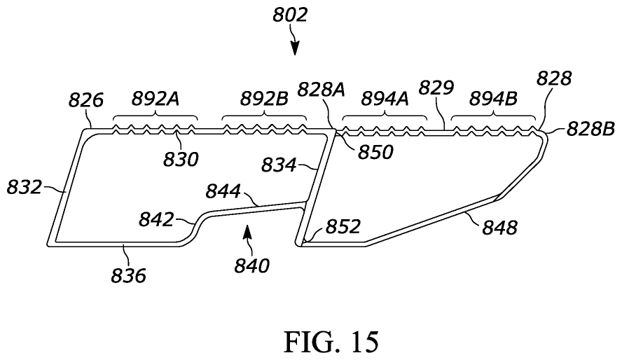

FIG. 15 shows a cantilevered step 802 according to an eighth embodiment. In the eighth embodiment, the cantilevered step 802 includes a different tread pattern, with different pip groupings than the first embodiment. Further, the shape of the channel 840 in first portion 826 of the cantilevered step 802 has a different shape than the channel 140 in the first embodiment. Elements in the eighth embodiment that are similar to those in the first embodiment have been given similar reference numbers in the eight-hundred series and only the general differences will be discussed below. For example, the cantilevered step 102 described in the first embodiment is numbered as cantilevered step 802 in the eighth embodiment.

The first portion 826 of the cantilevered step 802 includes a first wall 830, a second wall 832, a third wall 834, and a fourth wall 836. In the first portion 826 of the cantilevered step 802, the fourth wall 836 includes an indentation or channel 840 formed therein. The channel 840 is defined by a first channel wall 842, a second channel wall 844, and at least a portion of the third wall 834. The first channel wall 842 is disposed opposite the third wall 834 of the first portion 826. The second channel wall 844 extends between the first channel wall 842 and the third wall 834 of the first portion. In some configurations, the second channel wall 144 is disposed at an angle of between about 80 degrees and about 130 degrees, about 90 degrees and about 120 degrees, or about 90 degrees and about 110 degrees relative to the third wall 134.

The first wall 830 of the first portion 826 includes a tread pattern on an upper surface thereof having a first pip grouping 892A and a second pip grouping 892B. The first pip grouping 892A may include between about 2 pips and about 10 pips, between about 4 pips and about 10 pips, or between about 4 pips and about 8 pips. The second pip grouping 892B may include between about 2 pips and about 10 pips, between about 4 pips and about 10 pips, or between about 4 pips and about 8 pips. In some non-limiting examples, the number of pips in the first pip grouping 892A may be the same as the number of pips in the second pip grouping 892B.

The second portion 828 of the cantilevered step 802 includes a cantilevered wall 829 and an angled skirt 848. The cantilevered wall 829 is cantilevered from the third wall 834 at a first attachment surface 850. The angled skirt 848 extends inward toward the third wall 834 at an acute angle relative to the cantilevered wall 829 and joins the third wall 834 at a second attachment surface 852.

The cantilevered wall 829 includes a tread pattern on an upper surface thereof having a first pip grouping 894A and a second pip grouping 894B. The first pip grouping 894A may include between about 2 pips and about 10 pips, between about 4 pips and about 10 pips, or between about 4 pips and about 8 pips. The second pip grouping 894B may include between about 2 pips and about 10 pips, between about 4 pips and about 10 pips, or between about 4 pips and about 8 pips. In some examples, the number of pips in the first pip grouping 894A may be the same as the number of pips in the second pip grouping 894B. In some examples, the pip groupings on the first portion 826 are the same as the pip groupings on the second portion 828.

In some approaches, the cantilevered step 802 may have a maximum displacement of between about 0.01 inches and about 0.10 inches, between about 0.01 inches and about 0.08 inches, or between about 0.01 inches and about 0.06 inches.

It is contemplated that any of the features in the embodiments of the cantilevered steps described herein and depicted in FIGS. 1-15 may be combined in any manner. Any aspects of the various illustrated embodiments may be combined to form new combinations.

The ladders, components, and/or accessories described herein may be formed of a variety of materials and using a variety of manufacturing techniques. Such materials may include, e.g., metals, plastics, and other polymers, and/or composite materials. In addition, some portions of the ladder's components may be formed of one material and one or more other components or accessories may be formed of another similar, or entirely distinct material. In some configurations, the rails of the ladders may be formed of composite material such as fiberglass or fiberglass reinforced plastic (FRP) and may be manufactured via a pultrusion process. FRP materials may include various plastic resins, such as polyurethane or polyethylene, or may include various glass materials. It is contemplated that adjusting the FRP formula to use different material combinations may reduce material weight and/or cost. The rails may also be formed of a metal material such as aluminum or aluminum alloys and manufactured via an extrusion process. After extrusion or pultrusion, the ladder rails are typically cut to length. For box-shaped rails, a computerized numerical control (CNC) machine may machine or form one or more holes in the rails. For rails of other shapes, such as C-shaped or I-beam shaped rails, other tools such as a punch press may be leveraged to punch one or more holes into the rails.

The rungs of the ladders may be formed of composite materials such as fiberglass or carbon fiber. In some approaches, the rungs may also be formed of meatal materials such as magnesium, magnesium alloys, aluminum, or aluminum alloys. The rungs may be manufactured, for example, via an extrusion process and cut to length. The rungs may take a variety of shapes and may be, for example, rounded, D-shaped, or triangular. Further, the rungs may have a hollow or substantially hollow cross-section.

The rungs of a ladder may be attached to the rails in a variety of different manners. In one approach, the rungs and rails are forged together, such as by having the rungs being attached to the rails via a direct swage connection. In a direct swage connection, a rung is attached directly to the rails using a cold forming process, where a moving die shapes the rung around a hole that was pre-punched in the rail. Annealing operations may be used to soften the metal to prevent cracking. In other approaches, the rungs are attached to the rails via a rung-plate connection in addition to other attachment types. In a rung-plate connection, a rung is attached to a plate and the plate is attached to the rail via one or more rivets or other mechanical elements.

Other accessories and assemblies employed in the ladder, such as feet, locks, ropes, rope pullies, end caps, and/or knee braces may be made of materials such as rubber or plastics like polypropylene or any other suitable plastics. Plastic parts may be injection molded or insert molded. In some approaches, accessories and assemblies such as guide brackets, feet, knee braces, and/or locks, may be formed, extruded or stamped, from metal materials such as aluminum, aluminum alloys, or steel. Rubber feet may be riveted to a base of the ladder. Metal locks may be extruded and then cut to length. Rope pulleys may include extruded metal side portions and plastic round pulleys formed of injection molded plastic, with the side portions and pulley held together by a rivet. End caps may be riveted or snap fit to the ladder during assembly. Similarly, knee-caps may be riveted to the ladder.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

1. A ladder comprising:
a rail assembly including a first rail and a second rail spaced from and opposite the first rail; and
a cantilevered step coupled to the first rail and the second rail, the cantilevered step including:
a first portion disposed between the first rail and the second rail, the first portion including first wall, a second wall, and a third wall, the first wall forming at least a portion of a standing surface, the second wall and the third wall depending from the first wall; and
a second portion coupled to the first portion along the third wall at a first attachment surface and a second attachment surface, the second portion cantilevered from the first portion such that the second portion extends beyond the rail assembly.

2. The ladder of claim 1, wherein the cantilevered step has a maximum displacement of less than about 0.125 inches.

3. The ladder of claim 1, wherein the first portion has a cross-sectional shape that is at least one of C-shaped or box-shaped.

4. The ladder of claim 1, wherein the second portion includes a cantilevered wall that is cantilevered from the first attachment surface, wherein the cantilevered wall is coplanar with the first wall of the first portion.

5. The ladder of claim 4, wherein the second portion further includes a proximal end portion adjacent to the first portion and a distal end portion opposite the proximal end portion, the distal end portion including an angled skirt that depends from the cantilevered wall and extends toward the third wall to join the third wall at the second attachment surface.

6. The ladder of claim 1, wherein the first portion further includes a fourth wall disposed opposite the first wall and extending between the second wall and the third wall.

7. The ladder of claim 6, wherein the fourth wall includes a channel formed therein, the channel disposed adjacent to the third wall of the first portion.

8. The ladder of claim 1, wherein first portion and the second portion of the cantilevered step are hollow.

9. The ladder of claim 1, wherein the cantilevered step further includes at least one end cap that secured to open end of the cantilevered step via a friction fit connection.

10. A ladder comprising:
front rail assembly including a first front rail and a second front rail spaced from and opposite the first front rail;
a rear rail assembly coupled to the front rail assembly at a hinged portion, the rear rail assembly having a first rear rail and a second rear rail spaced from and opposite the first rear rail; and
a cantilevered step coupled to the front rail assembly, the cantilevered step including:
a first portion disposed between the first front rail and the second front rail, the first portion including a first wall, a second wall, and a third wall, the first wall forming at least a portion of a standing surface, the second wall and the third wall depending from the first wall; and
a second portion coupled to the first portion at a first attachment surface disposed on the third wall, the second portion cantilevered from the first attachment surface such that the second portion extends beyond the first front rail and the second front rail.

11. The ladder of claim 10, wherein the cantilevered step is disposed on the front rail assembly at a first position, wherein the rear rail assembly further includes a horizontal bar extending between the first rear rail and the second rear rail at a second position on the rear rail assembly, and wherein the second position is opposite the first position.

12. The ladder of claim 10, wherein the ladder further includes a first spreader and a second spreader coupled to the front rail assembly and the rear rail assembly, and wherein the cantilevered step is nested between the first spreader and the second spreader when the ladder is folded.

13. The ladder of claim 10, wherein the cantilevered step has a total step width that extends between the second wall and a distal edge of the second portion, wherein the ladder has a ladder width that extends between the front rail assembly and the rear rail assembly, and wherein the total step width is less than the ladder width.

14. The ladder of claim 10, wherein the second portion further includes an angled skirt that depends from a distal end of the second portion and couples to the third wall at a second attachment surface.

15. A step comprising:
a first portion comprising a first wall, a second wall, a third wall, and a fourth wall, the first wall forming a standing surface, the second wall and the third wall depending from the first wall, the fourth wall opposite the first wall and extending between the second wall and the third wall; and
a second portion coupled to the first portion, the second portion including a cantilevered wall and an angled skirt, the cantilevered wall cantilevered from a first attachment surface on the third wall, the angled skirt depending from a distal end of the cantilevered wall and extending inward toward the third wall at an acute angle relative to the cantilevered wall, the angled skirt intersecting the third wall at a second attachment surface.

16. The step of claim 15, wherein the fourth wall includes a channel formed therein, the channel disposed adjacent to the third wall, and wherein the channel is defined by at least a portion of the third wall of the first portion, a first channel wall, and a second channel wall, the first channel wall disposed opposite the third wall of the first portion, and the second channel wall extending between the first channel wall and the third wall of the first portion.

17. The step of claim 16, wherein the second channel wall is disposed at an angle of between about 90 degrees and about 150 degrees relative to the third wall.

18. The step of claim 15, wherein the second portion further includes a rib coupled to the cantilevered wall that extends into a hollow interior of the second portion.

19. The step of claim 15, wherein the second portion further includes a cross-brace coupled to the second portion that extends from the cantilevered wall to the third wall of the second portion.

20. The step of claim 19, wherein the cross-brace includes a second skirt that depends from the cantilevered wall and a third cantilevered wall that extends from the third wall of the second portion.
